(19) United States
(12) Patent Application Publication
(10) Pub. No.: US 2008/0307760 A1
(43) Pub. Date: Dec. 18, 2008

(54) Low shrinkage plugging mixture for ceramic filter, plugged honeycomb filter and method of manufacturing same

(76) Inventors: Shyam Lekhraj Chatlani, Big Flats, NY (US); Isabelle Marie Chauvel-Melscoet, Bois-Le-Roi (FR); Luiz Eduardo Ferri, Corning, NY (US)

Correspondence Address: CORNING INCORPORATED, SP-TI-3-1, CORNING, NY, 14831, US

(21) Appl. No.: 12/077,360

(22) Filed: Mar. 19, 2008

Related U.S. Application Data
(60) Provisional application No. 60/918,950, filed on Mar. 20, 2007.

(51) Int. Cl. B01D 46/24

(52) U.S. Cl. 55/523; 264/631; 501/39

(57) ABSTRACT

Disclosed are plugging mixtures for forming a ceramic honeycomb wall flow filter. The plugging mixtures exhibit a reduced percentage of volumetric shrinkage during the drying process and generally comprise an inorganic ceramic powder batch composition; an organic binder; a liquid vehicle; and a non-foaming volume transformation agent. Also disclosed are methods for forming plugged ceramic wall flow filters from such plugging mixtures and honeycomb articles produced therefrom.

This application claims the benefit of U.S. Provisional Application No. 60/918,950, filed Mar. 20, 2007, entitled “Low Shrinkage Plugging Mixture for Ceramic Filter, Plugged Honeycomb Filter and Method of Manufacturing Same.”

### FIELD OF THE INVENTION

The present invention relates to the manufacture of porous ceramic honeycomb structures, and more particularly to improved materials and processes for sealing selected channels of porous ceramic honeycombs to form plugged ceramic honeycomb filters.

### BACKGROUND

Ceramic wall flow filters are finding widening use for the removal of particulate matter from diesel or other combustion engine exhaust streams. Such filters are known as Diesel Particulate Filters (DPF's). A number of different approaches for manufacturing such filters from channeled honeycomb structures formed of porous ceramics are known. The most widespread approach is to position plugs of sealing material within various channels of such structures to block direct fluid flow through the channels and force the fluid stream through the porous channel walls of the honeycombs before exiting the filter. The DPF's used in diesel engine applications are typically formed from inorganic material systems, chosen to provide excellent thermal shock resistance, low engine back-pressure, and acceptable durability in use. The most common filter compositions are based on aluminum titanate, cordierite, and silicon carbide. Filter geometries are designed to minimize engine back-pressure and maximize filtration surface area per unit volume. Illustrative of this approach is U.S. Pat. No. 6,809,139, which describes the use of sealing materials comprising cordierite-forming (MgO—Al₂O₃—SiO₂) ceramic powder blends and thermosetting or thermoplastic binder systems to form such plugs.

DPF's typically consist of a parallel array of channels generally with every other channel on each face sealed in a checkered pattern such that exhaust gases from the engine would have to pass through the walls of the channels in order to exit the filter. DPF's of this configuration are typically formed by extruding a plasticized batch to form a matrix that makes up the array of parallel channels and then sealing or “plugging” certain channels with a sealant cement, generally in a secondary processing step. Initially, filters were created by plugging a fully fired matrix followed by a second fire to sinter or partially sinter the plugs. Optionally, the plugging process may also include plugging a matrix in the un-fired (or green) state, and then simultaneously firing the matrix and plug in a common firing cycle.

While the economics are overwhelmingly in favor of using a single fire process over a dual fire process, plugging a green honeycomb presents several challenges during manufacturing. First, the strength of an un-fired part is significantly lower than that of the fired part, so processes must be designed to minimize damage to these parts during handling and the processing of these parts. A second issue arises from the fact that water present in the plugging cement (as a vehicle) interacts with the organic binder in the un-fired matrix. This interaction may soften and even possibly deform or swell the matrix locally where plug cement is present. The softened matrix poses the issue in that cracks may more easily develop on the face of the filter during the subsequent drying of the plug cement. The generation of drying cracks during green plugging, as discussed above, is driven by stress generated at the plug/matrix interface along the channel due to plug cement drying shrinkage in combination with a softened matrix. A couple of approaches to minimize this re-wetting of the matrix or interaction of the organics with plug cement have been discussed in current literature. One approach discusses the use of plasticizers, such as oils and alcohols, that do not significantly re-dissolve the binder. Another approach involves reducing the amount of binder available for dissolution by preferentially burning out some of the binder in a preparatory step. Techniques for coating the walls of the channels to be plugged (e.g. passivation) in order to prevent the binder from re-wetting are also available in the literature.

Further, while the issue of softening and deformation of the matrix is an artifact of plugging un-fired parts, the formation of dimples or indents in plugs (generally at the plug's end) is an issue with plugging both un-fired and fired parts. Mechanical means of resolving dimples such as twisting the part during removal from plugging apparatus or blowing air have been attempted. Further, an approach to resolve dimples by using a mixture of two types of cement (a dilatant and a high viscosity cement) has also been attempted. While several explanations for the formation of these dimples are afforded in the literature, the simplest principle that explains this is that dimples, as best recognized and understood by the inventors herein, are formed due to a slip casting phenomenon. Water from the cement is absorbed by the matrix, leaving behind a void approximately equal in volume to the water removed by the matrix.

Accordingly, there is a need in the DPF plugging art for an improved plugging cement mixture for forming ceramic wall flow filters. In particular, there is a need for cement mixtures that exhibit reduced shrinkage during the drying process in order to reduce or even eliminate the formation of drying cracks. Furthermore, there is also a recognized need for plugging mixtures that can reduce or even eliminate the formation of undesired dimples or indentations on the interior and/or exterior surface of the plug.

### SUMMARY

The present invention provides improved cement mixtures, in particular cement plugging mixtures, useful, for example, for forming plugs in porous ceramic honeycomb wall-flow filters. The cement mixtures, and plugs formed therefrom, exhibit reduced drying shrinkage. For plugs, the reduced shrinkage occurs without adversely affecting the physical properties of the resulting fired plugs. In one embodiment, the plugging mixture's shrinkage during drying is offset by incorporating a non-foaming, volume transformation agent into the cement mixture. The non-foaming, volume transformation agent may expand in volume during drying, resulting in low net drying shrinkage. This volume expansion occurs at relatively low temperatures, for example, those temperatures associated with drying, i.e., less than or equal to 200° C. In addition to the reduced shrinkage, the plugging mixtures in accordance with embodiments of the present invention may also reduce or even eliminate the formation of undesired dimples on the surface and/or internally in the plug. According to embodiments, the volume transformation agent may further exhibit a volume transformation temperature (T_{VT}), wherein 50° C.≦T_{VT}≦200° C. In other embodiments, T_{VT}≦120° C., T_{VT}≦110° C., or even 50° C.≦T_{VT}≦110° C. Preferred volume transformation agents may include certain hydroscopic materials such as starches (e.g., potato starch), and non-hydroscopic materials such as gas-filled polymer micro-spheres. According to further embodiments, the cement mixture may form a cordierite phase upon firing.

In another embodiment, the present invention provides a plugging cement mixture for a ceramic honeycomb article, such as a wall flow filter, comprising a ceramic forming inorganic powder batch composition (such as a cordierite-forming batch mixture); an organic binder; a liquid vehicle; and a non-foaming volume transformation agent. The volume transformation agent may exhibit a volume transformation temperature (T_{VT}), wherein 50° C.≦T_{VT}≦200° C.

In another embodiment, the present invention provides a porous ceramic wall flow filter, comprising a honeycomb substrate defining a plurality of cell channels bounded by porous walls that extend longitudinally from an inlet end to an outlet end. A portion of the plurality of cell channels include a plug sealed to the respective walls. According to this embodiment, the plugs are formed from a plugging mixture of the present invention, comprising a ceramic forming inorganic powder batch composition; an organic binder; a liquid vehicle; and a non-foaming volume transformation agent exhibiting a volume transformation temperature (T_{VT}) wherein 50° C.≦T_{VT}≦200° C.

In still another embodiment, the present invention provides a method for manufacturing a porous ceramic wall flow filter. The method generally comprises providing a honeycomb structure defining a plurality of cell channels bounded by porous channel walls that extend longitudinally from an inlet end to an outlet end. A portion of at least one predetermined channel is selectively plugged with a plugging mixture of the present invention, comprised of a ceramic forming inorganic powder batch composition; an organic binder; a liquid vehicle; and a non-foaming volume transformation agent. The selectively plugged honeycomb structure can then be fired under conditions effective to form a sintered phase ceramic plug in the at least one selectively plugged channel. According to embodiments, the non-foaming volume transformation agent may exhibit a volume transformation temperature (T_{VT}) wherein 50° C.≦T_{VT}≦200° C.

In still another embodiment, the present invention is a green body honeycomb article, comprising a green body honeycomb structure defining a plurality of cell channels bounded by longitudinally extending walls; a plug formed in at least one cell channel of the green body honeycomb structure wherein the plug contains a plugging mixture of a ceramic forming inorganic powder batch composition; an organic binder; a liquid vehicle; and a non-foaming volume transformation agent exhibiting a volume transformation temperature (T_{VT}) wherein 50° C.≦T_{VT}≦200° C.

In yet another embodiment, the present invention is a cement mixture for a ceramic honeycomb article, comprising a ceramic forming inorganic powder batch composition; an organic binder; a liquid vehicle; and a volume transformation agent having a volume transformation temperature (T_{VT}) wherein T_{VT}≦120° C. The ceramic forming inorganic powder batch may be a cordierite-forming powder batch mixture.

In still yet another embodiment, the present invention is a porous ceramic honeycomb filter, comprising a porous ceramic honeycomb substrate having cell channels bounded by cell walls; a portion of the cell channels including plugs. The plugs exhibit substantially uniform sectional numerical aperture across a width thereof from wall to adjacent wall. In particular, a sectional numerical aperture measured across a width of the plug may vary by less than 10%, or even less than 8%. In another aspect, the standard deviation of the SNA is less than 2% from the average SNA across the plug.

Additional embodiments of the invention will be set forth, in part, in the detailed description, and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain embodiments of the instant invention and together with the description, serve to explain, without limitation, the principles of the invention.

FIGS. 1A and 1B illustrate exemplary volumetric expansion of potato starch according to one aspect of the present invention.

FIGS. 2A and 2B illustrate exemplary volumetric expansion of gas encapsulated microspheres according to one aspect of the present invention.

FIG. 3 illustrates an exemplary plugged wall flow filter according to one embodiment of the present invention.

FIG. 4 illustrates a comparison of exemplary volumetric shrinkage data for plugging mixtures of the present invention and conventional plugging mixtures.

FIGS. 5A and 5B illustrate comparisons of dimple formation resulting from a conventional plugging mixture compared to a plugging mixture according to one aspect of the present invention, which results in no visible dimple formation.

FIGS. 6A-6F illustrate cross-sectional and top view comparisons of plugging mixtures of the present invention in a dried green state compared to conventional plugging mixtures in a dried green state.

FIGS. 7A and 7B is a cross-sectional and top view illustration, respectively, of plugging mixtures of the present invention in a fired state.

FIG. 8 is a cross-sectional side view of a porous fired plug according to embodiments of the present invention exhibiting substantially uniform porosity and sectional numerical aperture across the width of the plug.

FIG. 9 is a graph of sectional numerical aperture (%) versus position across the cell width X (mm) illustrating the substantially constant sectional numerical aperture across the width of the plug.

FIG. 10 is a graph of Temperature (° C.) versus Relative Change in Volume (%) illustrating the substantial change is volume of the volume expansion agent with temperature.

### DETAILED DESCRIPTION

The following description of the invention is provided as an enabling teaching of the invention in its best, currently known embodiment. To this end, those skilled in the relevant art will recognize and appreciate that many changes can be made to the various embodiments of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a “volume transformation agent” includes embodiments having two or more such volume transformation agents unless the context clearly indicates otherwise.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, a “wt. %” or “weight percent” or “percent by weight” of a component, unless specifically stated to the contrary, is based on the total weight of the composition or article in which the component is included.

As briefly summarized above, the present invention provides a plugging mixture generally comprised of a ceramic-forming inorganic powder batch composition; an organic binder; a liquid vehicle; and a volume transformation agent. The plugging mixtures are suitable for use in forming porous ceramic wall flow filters. Among several advantages over existing plugging mixtures, the plugging mixtures can exhibit reduced drying shrinkage during the firing process, and, therefore, can result in the formation of fewer or even no drying cracks relative to the plugging mixtures of the current art. In another embodiment, the plugging mixtures can also reduce or even eliminate the formation of dimples or indentations on the end surface of the resulting plug.

As used herein, a volume transformation agent refers to a plugging mixture component that is capable of expanding volumetrically when heated. The volume transformation agent includes a measured volume transformation temperature which provides a measure of the degree of volume expansion at temperature. According to one embodiment of the present invention, the volume transformation agent is a non-foaming agent or, alternatively, the volume transformation agent is not a foaming agent. In use, the volume expansion of the volume transformation agent can at least partially offset any shrinkage that may occur in the cement (e.g., plugging mixture) during firing. In particular, the volume transformation agent includes a volume transformation temperature (T_{VT}), defined herein as the temperature at which the volume increases by a factor of 2× as compared to its fully dry room temperature volume. In the case of hydroscopic volume transformation agents, the volume transformation temperature is determined in the presence of water. In the case of non-hydroscopic volume transformation agents, the volume transformation temperature is determined in the absence of water. Exemplary volume transformation temperatures according to aspects of the invention may be in the range of from approximately 50° C. to approximately 200° C., including for example, temperatures of less than or equal to 120° C., less than or equal to 110° C., temperatures in the range of from 50° C. to 120° C., or even temperatures in the range of from 50° C.-100° C. The volume transformation temperature may be less than the drying temperature utilized for drying the plug.

In one embodiment, the volume transformation agent in the plugging cement mixture can be comprised of a hydroscopic starch material, such as a potato starch pore forming agent. According to this embodiment, the potato starch pore former can, for example, undergo a phase transformation when subjected to plugging material drying conditions. In particular, the pore former can absorb at least a portion of the liquid vehicle contained within the plugging mixture. The absorption of the liquid vehicle, such as water, can then result in a volume transformation sufficient to at least partially offset any shrinkage that may otherwise occur due to liquid vehicle loss from the plugging mixture during the drying process. Any commercially available potato starch can be used as a suitable volume expansion agent. However, in one embodiment, the potato starch may have a median particle size d₅₀ in the range of from 40 μm to 50 μm.

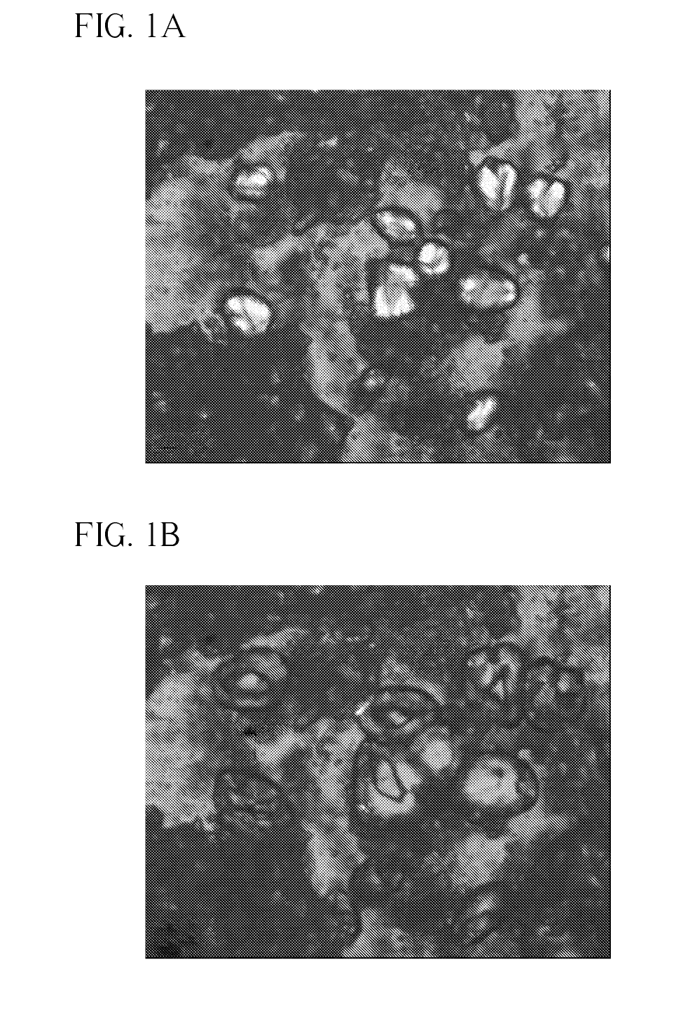

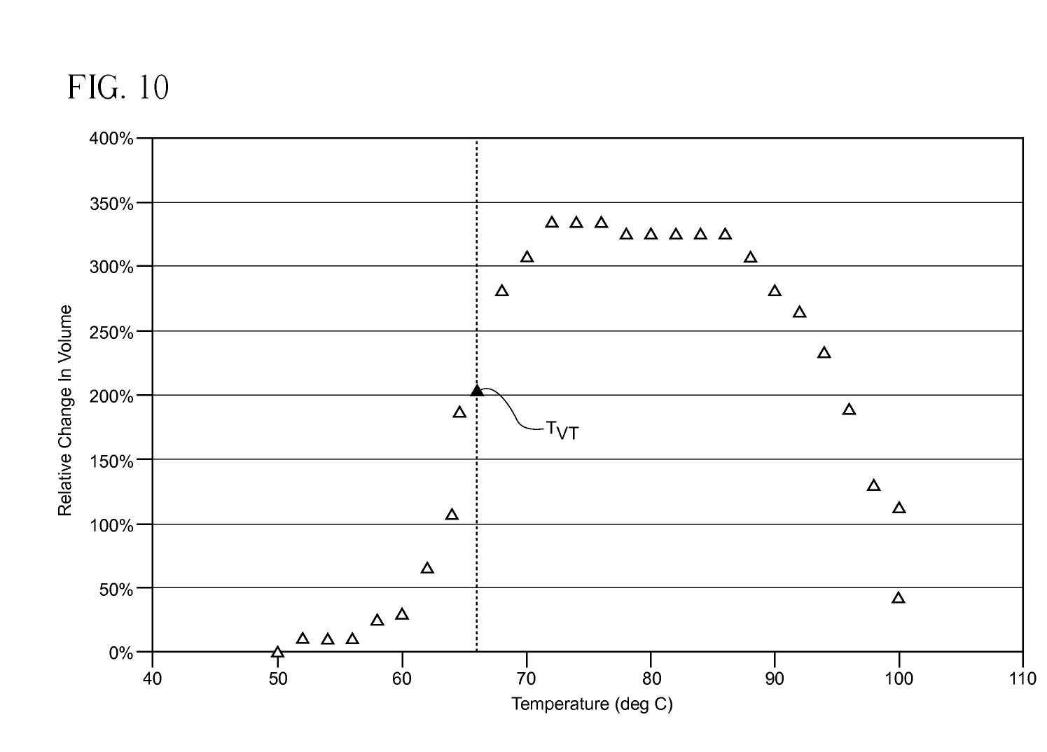

With reference to FIGS. 1A and 1B, the volume transformation (expansion) of an exemplary potato starch is shown. In particular, FIG. 1A shows starch particles in a fully wet plugging cement mixture of the present invention at a temperature of approximately 50° C. In contrast, FIG. 1B shows the same starch particles in a wet plugging mixture of the present invention at a temperature of approximately 70° C. As illustrated, the starch particles in FIG. 1B have almost doubled in size, i.e., they have substantially expanded in volume. In the case of the volumetric expansion agent comprising a starch, the volume transformation is determined by heating the material and measuring its volumetric expansion in the presence of H₂O. For starches, the volumetric transformation temperature is the temperature at which the volume expands to 2× (200%) the room temperature volume of the starch (as mixed with the vehicle only) when heated on a hot plate (in the presence of a sufficient amount of the vehicle) at a temperature rate of 10° C./minute. FIG. 10 illustrates a plot of the relative change in volume (in %) of a representative potato starch particle (obtained optically). As is evident from the data, the volume transformation temperature (labeled T_{VT}) occurs below 120° C., and in particular below 100° C., or even below 90° C. In this embodiment of potato starch, the volume transformation temperature (T_{VT}) occurs between 50° C. and 80° C. Even though the volume of the starch contracts after expanding (for example, above 90° C.), the cement, and specifically, the binder are already set up, such that in spite of the starch contraction, no dimples are formed in the plugs, and no significant additional shrinkage takes place. Thus, it should be recognized that it is desirable that the cement be set up sufficiently before any significant contraction of the volume transformation agent occurs. For example, set up of the material may occur before the volume expansion contracts less than 50% from its maximum volume. Most preferably, the set up of the cement should occur before the 2× volume is reached, during contraction, such that the effect of the volume expansion agent is not lost.

In another embodiment, the volume transformation agent may be comprised of a non-hydroscopic material, such as a plurality of gas encapsulated polymer micro-spheres. According to this embodiment, when the gas encapsulated polymer micro-spheres are subjected to heating conditions over the plugging cement mixture drying profile, the gas encapsulated within the microsphere can expand. The increased pressure from the expanding gas can lead to an increased volume of the microsphere, thus at least partially offsetting any shrinkage that may otherwise occur due to liquid vehicle loss from the plugging mixture during the drying process. Exemplary microspheres suitable for use in the plugging mixtures of the present invention include hollow polymeric microspheres. For example, commercially available Expancel® expandable polymeric microspheres, available from Expancel Inc. (subsidiary of Akzo Nobel) Duluth, Ga. USA may be used.

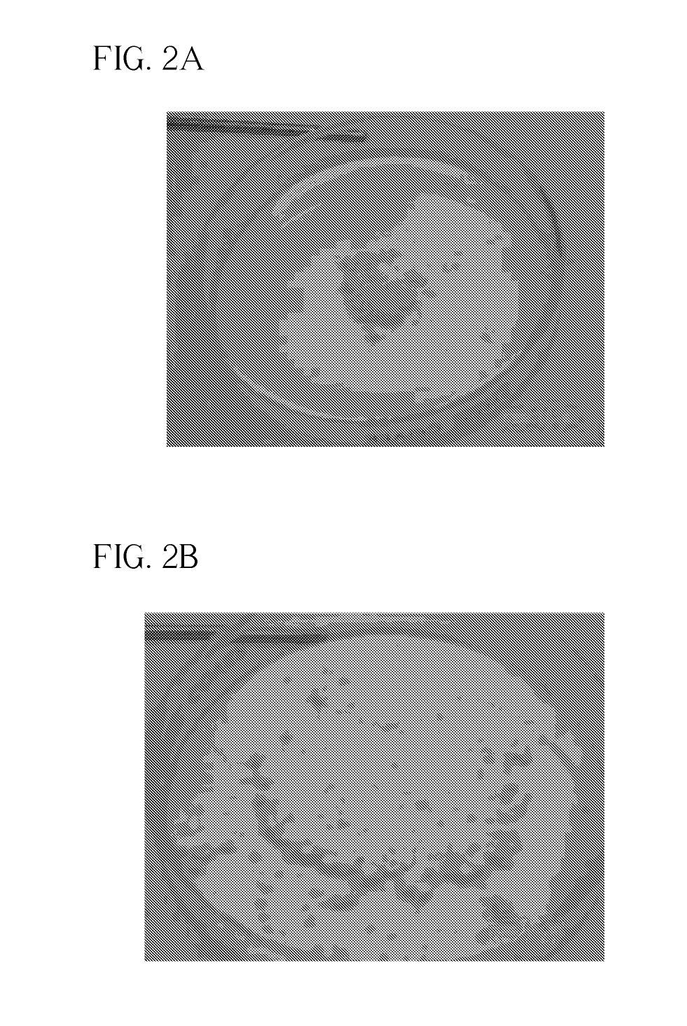

With reference to FIGS. 2A and 2B, the volume transformation (expansion) of exemplary expandable polymer microspheres is shown. In particular, the exemplified microspheres are the expandable Expancel® 642 WU 40 microspheres. These exemplary microspheres are small spherical plastic particles consisting of a polymer shell encapsulating a gas. When the gas inside the shell is heated, it increases its pressure and the thermoplastic shell softens, resulting in a dramatic increase in the volume of the micro-spheres. When fully expanded, the volume of the micro-spheres can for example increase up to more than 40 times in volume. A comparison of FIGS. 2A and 2B illustrate the substantial volumetric expansion of the exemplified microspheres upon heating. In determining the volume transformation temperature of the micro-spheres, they may simply be heated on a hot plate at a temperature rate of 10° C./minute to determine the temperature (in ° C.) at which the volume is 2× the room temperature volume.

The volume transformation agent can be incorporated into the plugging cement mixture in any desired amount. However, in one embodiment, it is preferred that the volume transformation agent be present in the plugging cement mixture as a super addition, and in an amount in the range of from approximately 1.0 weight percent to approximately 15 weight percent of the ceramic-forming inorganic powder batch composition. Still further, in another embodiment it is desirable for the volume transformation agent to be present as a super addition in an amount in the range of from 8 weight percent to 13 weight percent of the ceramic-forming reactive inorganic powder batch composition.

The inorganic ceramic-forming powder batch composition may be a reactive inorganic powder batch composition, for example. The inorganic powder batch composition may be comprised of any desired combination of inorganic batch components sufficient to form a desired sintered phase ceramic composition, including for example a predominant sintered phase composition comprised of ceramic, glass-ceramic, glass, and combinations thereof. It should be understood that, as used herein, combinations of glass, ceramic, and/or glass-ceramic compositions includes both physical and/or chemical combinations, e.g., mixtures or composites. To this end, exemplary and non-limiting inorganic powder materials suitable for use in these inorganic ceramic powder batch mixtures can include cordierite, aluminum titanate, mullite, clay, kaolin, magnesia forming sources, talc, zircon, zirconia, spinel, alumina forming sources, including aluminas and their precursors, silica forming sources, including silicas and their precursors, silicates, aluminates, lithium aluminosilicates, alumina silica, feldspar, titania forming sources, fused silica, nitrides, carbides, borides, e.g., silicon carbide, silicon nitride or mixtures of these.

For example, in one embodiment, the plugging mixture of the present invention can comprise an aluminum titanate based ceramic forming inorganic powder batch composition mixture that can be heat treated under conditions effective to provide a sintered phase aluminum titanate based ceramic plug. In accordance with this embodiment, the inorganic powder batch composition comprises reaction sintered powdered raw materials, including an alumina forming source, a silica forming source, and a titania forming source. These inorganic powdered raw materials can, for example, be selected in amounts suitable to provided a sintered phase aluminum titanate ceramic composition comprising, as characterized in an oxide weight percent basis, from about 8 to about 15 percent by weight SiO₂, from about 45 to about 53 percent by weight Al₂O₃, and from about 27 to about 33 percent by weight TiO₂. An exemplary inorganic aluminum titanate precursor powder batch composition can comprises approximately 10% quartz; approximately 47% alumina; approximately 30% titania; and approximately 13% additional inorganic additives. Additional exemplary non-limiting inorganic batch component mixtures suitable for forming aluminum titanate include those disclosed in U.S. Pat. Nos. 4,483,944; 4,855,265; 5,290,739; 6,620,751; 6,942,713; 6,849,181; U.S. Patent Application Publication Nos.:2004/0020846; 2004/0092381; and in PCT Application Publication Nos.: WO 2006/015240; WO 2005/046840; and WO 2004/011386. The entire disclosures of the aforementioned references are hereby incorporated by reference.

In an alternative embodiment, the plugging mixture of the present invention can comprise a cordierite based ceramic forming inorganic powder batch composition mixture that can be heat treated under conditions effective to provide a sintered phase cordierite based ceramic plug. According to one cordierite ceramic forming embodiment, the ceramic forming inorganic powder batch composition may be a cordierite forming inorganic powder batch composition, comprising a magnesia forming source; an alumina forming source; and a silica forming source. For example, and without limitation, the inorganic ceramic powder batch composition can be selected to provide a ceramic article which comprises at least about 93% by weight cordierite, the cordierite consisting essentially of from about 49 to about 53 percent by weight SiO₂, from about 33 to about 38 percent by weight Al₂O₃, and from about 12 to about 16 percent by weight MgO. To this end, and exemplary inorganic cordierite precursor powder batch composition can comprise about 33 to about 41 weight percent alumina forming source, about 46 to about 53 weight percent of a silica forming source, and about 11 to about 17 weight percent of a magnesia forming source. Some additional exemplary ceramic batch material compositions for forming cordierite include those disclosed in U.S. Pat. No. 3,885,977 which is herein incorporated by reference.

It should be understood that the inorganic ceramic powder batch materials suitable for use in forming the plugging mixtures of the present invention can be synthetically produced materials such as oxides, hydroxides, and the like. Alternatively, they can be naturally occurring minerals such as clays, talcs, or any combination of these. Still further, the powder batch compositions can comprise any desired mixture of both synthetic and naturally occurring materials. Thus, it should be understood that the present invention is not limited to the types of powders or raw materials, as such can be selected depending on the properties desired in the final ceramic body. Further, the inorganic ceramic powder materials are generally fine powder (in contrast to coarse grained materials) some components of which can either impart plasticity, such as clays, when mixed with a liquid vehicle such as water, or which when combined with organic materials such as methyl cellulose or polyvinyl alcohol can contribute to plasticity.

As used herein, an alumina forming source is a powder, which when heated to a sufficiently high temperature in the absence of other raw materials, yields substantially pure aluminum oxide. Exemplary and non-limiting examples of alumina forming sources include corundum or alpha-alumina, gamma-alumina, transitional aluminas, aluminum hydroxide such as gibbsite and bayerite, boehmite, diaspore, aluminum isopropoxide and the like. The median particle size of the alumina source is preferably greater than 5 μm, including for example, median particle sizes up to 10 μm, 15 μm, 20 μm, or even 25 μm. Commercially available alumina sources can include relatively coarse aluminas, having a particle size of about 4-6 micrometers, and a surface area of about 0.5-1 m²/g, and relatively fine aluminas having a particle size of about 0.5-2 micrometers, and a surface area of about 8-11 m²/g.

If desired, the alumina forming source can comprise a dispersible alumina forming source. As used herein, a dispersible alumina forming source is an alumina forming source that is at least substantially dispersible in a solvent or liquid medium and that can be used to provide a colloidal suspension in a solvent or liquid medium. In one embodiment, a dispersible alumina source can be a relatively high surface area alumina source having a specific surface area of at least 20 m²/g. Alternatively, a dispersible alumina source can have a specific surface area of at least 50 m²/g. In an exemplary embodiment, a suitable dispersible alumina source for use in the methods of the instant invention comprises alpha aluminum oxide hydroxide (AlOOH.x.H₂O) commonly referred to as boehmite, pseudoboehmite, and as aluminum monohydrate. In another exemplary embodiment, the dispersible alumina source can comprise the so-called transition or activated aluminas (i.e., aluminum oxyhydroxide and chi, eta, rho, iota, kappa, gamma, delta, and theta alumina) which can contain various amounts of chemically bound water or hydroxyl functionalities.

Suitable silica forming sources can in one embodiment comprise clay or mixtures, such as for example, raw kaolin, calcined kaolin, and/or mixtures thereof. Exemplary and non-limiting clays include non-delaminated kaolinite raw clay, having a particle size of about 7-9 micrometers, and a surface area of about 5-7 m²/g, those having a particle size of about 2-5 micrometers, and a surface area of about 10-14 m²/g, and K-10 raw clay, delaminated kaolinite having a particle size of about 1-3 micrometers, and a surface area of about 13-17 m²/g, calcined clay, having a particle size of about 1-3 micrometers, and a surface area of about 6-8 m²/g.

In a further embodiment, it should also be understood that the silica forming source can further comprise crystalline silica such as quartz or cristobalite, non-crystalline silica such as fused silica or sol-gel silica, silicone resin, zeolite, and diatomaceous silica. In still another embodiment, the silica forming source can comprise a compound that forms free silica when heated, such as for example, silicic acid or a silicon organo-metallic compound.

In the case of aluminum titanate plugs, the titania forming source is preferably selected from, but not limited to, the group consisting of rutile and anatase titania. In one embodiment, optimization of the median particle size of the titania source can be used to avoid entrapment of unreacted oxide by the rapidly growing nuclei in the sintered ceramic structure. Accordingly, in one embodiment, it is preferred for the median particle size of the titania to be up to 20 micrometers.

Exemplary and non-limiting magnesia forming sources can include talc. In a further embodiment, suitable talcs can comprise talc having a mean particle size of at least about 5 μm, at least about 8 μm, at least about 12 μm, or even at least about 15 μm. Particle size is measured by a particle size distribution (PSD) technique, preferably by a Sedigraph by Micrometrics. Talc have particle sizes of between 15 and 25 μm are preferred. In still a further embodiment, the talc can be a platy talc. As used herein, a platy talc refers to talc that exhibits a platelet particle morphology, i.e., particles having two long dimensions and one short dimension, or, for example, a length and width of the platelet that is much larger than its thickness. In one embodiment, the talc possesses a morphology index (MI) of greater than about 0.50, 0.60, 0.70, or 80. To this end, the morphology index, as disclosed in U.S. Pat. No. 5,141,686, is a measure of the degree of platiness of the talc. One typical procedure for measuring the morphology index is to place the sample in a holder so that the orientation of the platy talc is maximized within the plane of the sample holder. The x-ray diffraction (XRD) pattern can then be determined for the oriented talc. The morphology index semi-quantitatively relates the platy character of the talc to its XRD peak intensities using the following equation:

$$M = \frac{{I}_{x}}{{I}_{x} + 2 {I}_{y}}$$

where Iₓ is the intensity of the peak and I_{y} is that of the reflection.

The inorganic ceramic powder batch composition comprising the aforementioned ceramic forming raw materials can be mixed together with the volume transformation agent as described above, an organic binder system, and a liquid vehicle, in order to provide the plugging cement mixture of the present invention. As understood by one of ordinary skill in the art, the incorporation of an organic binder into the ceramic precursor batch composition can further contribute to the cohesion and plasticity of the plugging mixture for shaping the mixture and for plugging selected portions of a honeycomb body.

The preferred liquid vehicle for providing a flowable or paste-like consistency to these plugging mixtures is water, although as mentioned other liquid vehicles exhibiting solvent action with respect to suitable temporary binders can be used. To this end, the amount of the liquid vehicle component can vary in order to in part optimum handling properties and compatibility with the other components in the ceramic batch mixture. Typically, the liquid vehicle content is usually present as a super addition in an amount in the range of from 15% to 60% by weight of the plasticized composition, and more preferably in the range of from 20% to 50% by weight of the plasticized composition. However, it should also be understood that in another embodiment, it is desirable to utilize as little liquid vehicle component as possible while still obtaining a paste like consistency capable of being forced into selected ends of a honeycomb substrate. Minimization of liquid components in the plugging mixtures can lead to further reductions in the drying shrinkage of the plugging mixture during the drying process.

Suitable temporary binders for use in plugging mixtures incorporating the preferred water vehicle include water soluble cellulose ether binder such as methylcellulose, hydroxypropyl methylcellulose, methylcellulose derivatives, and/or any combinations thereof. Particularly preferred examples include methyl cellulose and hydroxypropyl methyl cellulose. Typically, the organic binder is present in the plugging mixture as a super addition in an amount in the range of from 0.1 weight percent to 5.0 weight percent of the aluminum titanate precursor reactive batch composition, and more preferably, in an amount in the range of from 0.5 weight percent to 2.0 weight percent of the ceramic forming precursor batch composition.

The plugging mixture can optionally comprise at least one additional processing aid and or additive such as a plasticizer, lubricant, surfactant, sintering aid, and/or pore former. An exemplary plasticizer for use in preparing the plugging mixture is glycerine. An exemplary lubricant can be a hydrocarbon oil or tall oil. A pore former, may also be optionally used to optimize the porosity and/or median pore size of the resulting plug material. Exemplary and non-limiting pore formers can include graphite, starch, polyethylene beads, and flour.

The addition of the optional sintering aid can enhance the strength of the ceramic plug structure after firing. Suitable sintering aids can generally include an oxide source of one or more metals such as strontium, barium, iron, magnesium, zinc, calcium, aluminum, lanthanum, yttrium, titanium, bismuth, or tungsten. In one embodiment, it is preferred that the sintering aid comprise a mixture of a strontium oxide source, a calcium oxide source, and an iron oxide source. In another embodiment, it is preferred that the sintering aid comprise at least one rare earth metal. Still further, it should be understood that the sintering aid can be added to the plugging mixture in a powder and/or a liquid form.

Still further, plugging mixtures of the present invention can optionally comprise one or more pre-reacted inorganic refractory fillers having expansion coefficients reasonably well matched to those of common wall flow filter materials in which the plugging material can be used. Exemplary pre-reacted inorganic refractory fillers can include powders of silicon carbide, silicon nitride, cordierite, aluminum titanate, calcium aluminate, beta-eucryptite, and beta-spodumene, as well as refractory aluminosilicate fibers formed, for example, by the processing of aluminosilicate clay. The optional pre-reacted inorganic refractory fillers can be utilized in the plugging mixture to optimize or control the shrinkage and/or rheology of the plugging paste during firing process.

As further summarized above, the plugging mixtures of the present invention can be used to provide a plugged porous ceramic wall flow filter. In particular, these plugging cement mixtures are well suited for providing plugged ceramic honeycomb bodies. For example, in one embodiment, a plugged ceramic wall flow filter can be formed from a honeycomb substrate that defines a plurality of cell channels bounded by porous channel walls that extend longitudinally from an upstream inlet end to a downstream outlet end. A first portion of the plurality of cell channels can comprise a plug, formed from a plugging mixture as described herein, and sealed to the respective channel walls at or near the downstream outlet end to form inlet cell channels. A second portion of the plurality of cell channels can also comprise a plug, formed from a plugging mixture as described herein, and sealed to the respective channel walls at or near the upstream inlet end to form outlet cell channels. Notably, however, the plugging mixture may be placed at any desirable location within the cell channel thereby forming plugs at any desired location, and is not restricted to be located only at the ends.

Accordingly, the present invention further provides a method for manufacturing a porous ceramic wall flow filter having a ceramic honeycomb structure and a plurality of channels bounded by porous ceramic walls, with selected channels each incorporating a plug sealed to the channel wall. The method generally comprises the steps of providing a honeycomb structure defining a plurality of cell channels bounded by porous channel walls that extend longitudinally from an upstream inlet end to a downstream outlet end and plugging at least one predetermined channel with a plugging cement mixture as described herein. The plugged honeycomb structure can then be fired under conditions effective to form a sintered phase ceramic plug in the at least one selectively plugged channel.

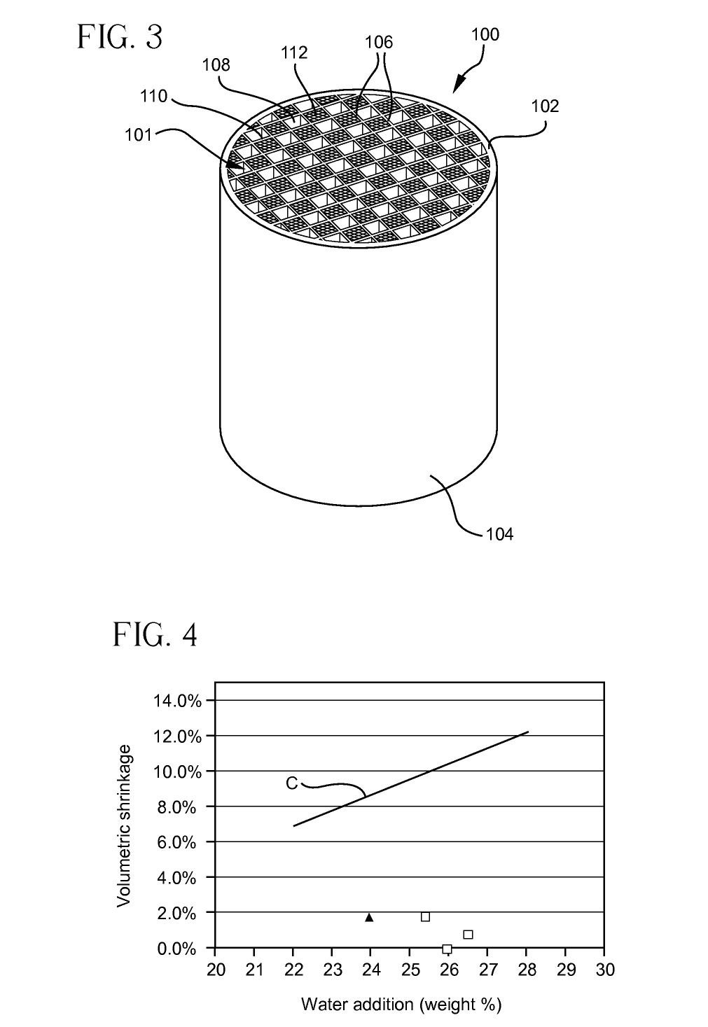

With reference to FIG. 3, an exemplary plugged wall flow filter 100 is shown. As illustrated, the wall flow filter 100 preferably has an upstream inlet end 102 and a downstream outlet end 104, and a multiplicity of cells 108 (inlet), 110 (outlet) extending longitudinally from the inlet end to the outlet end. The multiplicity of cells is formed from intersecting porous cell walls 106. A first portion of the plurality of cell channels are plugged with plugs 112 at or near the downstream outlet end (not shown) to form inlet cell channels and a second portion of the plurality of cell channels are plugged at or near the upstream inlet end with plugs 112 to form outlet cell channels. The exemplified plugging configuration forms alternating inlet and outlet channels such that a fluid stream flowing into the reactor through the open cells at the inlet end 102, then through the porous cell walls 106, and out of the reactor through the open cells at the outlet end 104. The exemplified end plugged cell configuration can be referred to herein as a “wall flow” configuration since the flow paths resulting from alternate channel plugging direct a fluid stream being treated to flow through the porous ceramic cell walls prior to exiting the filter.

The honeycomb substrate can be formed from any conventional material suitable for forming a porous monolithic honeycomb body. For example, in one embodiment, the substrate can be formed from a plasticized ceramic forming composition. Exemplary ceramic forming compositions can include those conventionally known for forming cordierite, aluminum titanate, silica carbide, aluminum oxide, zirconium oxide, zirconia, magnesium, stabilized zirconia, zirconia stabilized alumina, yttrium stabilized zirconia, calcium stabilized zirconia, alumina, magnesium stabilized alumina, calcium stabilized alumina, titania, silica, magnesia, niobia, ceria, vanadia, nitride, carbide, or any combination thereof.

The honeycomb substrate can be formed according to any conventional process suitable for forming honeycomb monolith bodies. For example, in one embodiment a plasticized ceramic forming batch composition can be shaped into a green body by any known conventional ceramic forming process, such as, e.g., extrusion, injection molding, slip casting, centrifugal casting, pressure casting, dry pressing, and the like. Typically, a ceramic precursor batch composition comprises inorganic ceramic forming batch component(s) capable of forming, for example, one or more of the sintered phase ceramic compositions set forth above, a liquid vehicle, a binder, and one or more optional processing aids and additives including, for example, lubricants, and/or a pore former. In an exemplary embodiment, extrusion can be done using a hydraulic ram extrusion press, or a two stage de-airing single auger extruder, or a twin screw mixer with a die assembly attached to the discharge end. In the latter, the proper screw elements are chosen according to material and other process conditions in order to build up sufficient pressure to force the batch material through the die.

The formed monolithic honeycomb can have any desired cell density. For example, the exemplary monolith 100 may have a cellular density from about 70 cells/in² (10.9 cells/cm²) to about 400 cells/in² (62 cells/cm²). Still further, as described above, a portion of the cells 110 at or near the inlet end 102 are plugged with a paste having the same or similar composition to that of the body 101. The plugging is preferably performed at the ends of the cells and form plugs 112 typically having a depth of about 5 to 20 mm, although this can vary. A portion of the cells on the outlet end 104 but not corresponding to those on the inlet end 102 may also be plugged in a similar pattern. Therefore, each cell is preferably plugged only at one end. The preferred arrangement is to therefore have every other cell on a given face plugged as in a checkered pattern as shown in FIG. 3. Further, the inlet and outlet channels can be any desired shape. However, in the exemplified embodiment shown in FIG. 3, the cell channels are typically square shape.

It should be understood that one of ordinary skill in the art will be able to determine and optimize a desired ceramic forming batch composition suitable for forming a particularly desired ceramic honeycomb substrate without requiring any undue experimentation. For example, the inorganic batch components can be selected so as to yield a ceramic honeycomb article comprising cordierite, mullite, spinel, aluminum titanate, or a mixture thereof upon firing. For example, and without limitation, in one embodiment, the inorganic batch components can be selected to provide a cordierite composition consisting essentially of, as characterized in an oxide weight percent basis, from about 49 to about 53 percent by weight SiO₂, from about 33 to about 38 percent by weight Al₂O₃, and from about 12 to about 16 percent by weight MgO. To this end, an exemplary inorganic cordierite precursor powder batch composition preferably comprises about 33 to about 41 weight percent aluminum oxide source, about 46 to about 53 weight percent of a silica source, and about 11 to about 17 weight percent of a magnesium oxide source. Exemplary non-limiting inorganic batch component mixtures suitable for forming cordierite include those disclosed in U.S. Pat. Nos. 3,885,977; RE 38,888; 6,368,992; 6,319,870; 6,24,437; 6,210,626; 5,183,608; 5,258,150; 6,432,856; 6,773,657; 6,864,198; and U.S. Patent Application Publication Nos.: 2004/0029707; 2004/0261384.

Alternatively, in another embodiment, the inorganic batch components can be selected to provide, upon firing, a mullite composition consisting essentially of, as characterized in an oxide weight percent basis, from 27 to 30 percent by weight SiO₂, and from about 68 to 72 percent by weight Al₂O₃. An exemplary inorganic mullite precursor powder batch composition can comprise approximately 76% mullite refractory aggregate; approximately 9.0% fine clay; and approximately 15% alpha alumina. Additional exemplary non-limiting inorganic batch component mixtures suitable for forming mullite include those disclosed in U.S. Pat. Nos. 6,254,822 and 6,238,618.

Still further, the inorganic batch components can be selected to provide, upon firing, an alumina titanate composition consisting essentially of, as characterized in an oxide weight percent basis, from about 8 to about 15 percent by weight SiO₂, from about 45 to about 53 percent by weight Al₂O₃, and from about 27 to about 33 percent by weight TiO₂. An exemplary inorganic aluminum titanate precursor powder batch composition can comprises approximately 10% quartz; approximately 47% alumina; approximately 30% titania; and approximately 13% additional inorganic additives. Additional exemplary non-limiting inorganic batch component mixtures suitable for forming aluminum titanate include those disclosed in U.S. Pat. Nos. 4,483,944; 4,855,265; 5,290,739; 6,620,751; 6,942,713; 6,849,181; U.S. Patent Application Publication Nos.:2004/0020846; 2004/0092381; and in PCT Application Publication Nos.: WO 2006/015240; WO 2005/046840; and WO 2004/011386.

The optimum firing schedule for converting a formed green body into a sintered phase ceramic composition will also be readily obtainable by one of ordinary skill in the art and, as such, the details of particular firing schedules will not be discussed herein.

Once the honeycomb substrate is formed, a plugging mixture as described herein can then be forced into selected open cells of a honeycomb substrate in the desired plugging pattern and to the desired depth, by one of several conventionally known plugging process methods. For example, selected channels can be end plugged as shown in FIG. 3 to provide a “wall flow” configuration whereby the flow paths resulting from alternate channel plugging direct a fluid or gas stream entering the upstream inlet end of the exemplified honeycomb substrate, through the porous ceramic cell walls prior to exiting the filter at the downstream outlet end.

The plugged honeycomb structure and can then be dried, and subsequently fired under conditions effective to convert the plugging material into a primary sintered phase ceramic composition. Conditions effective for drying the plugging material functionally include those conditions capable of removing at least substantially all of the liquid vehicle present within the plugging mixture. As used herein, at least substantially all include the removal of at least 95%, at least 98%, at least 99%, or even at least 99.9% of the liquid vehicle present in the plugging mixture. Exemplary and non-limiting drying conditions suitable for removing the liquid vehicle include heating the end plugged honeycomb substrate at a temperature of at least 50° C., at least 60° C., at least 70° C., at least 80° C., at least 90° C., at least 100° C., at least 110° C., at least 120° C., at least 130° C., at least 140° C., or even at least 150° C. for a period of time sufficient to at least substantially remove the liquid vehicle from the plugging mixture. In one embodiment, the conditions effective to at least substantially remove the liquid vehicle comprise heating the plugging mixture at a temperature in the range of from 60° C. to 120° C. Further, the heating can be provided by any conventionally known method, including for example, hot air drying, or RF and/or microwave drying.

During drying, conventional plugging mixtures result in the formation of undesirable cracks as a result of significant shrinkage that occurs during the drying process. In contrast however, the plugging mixtures of the present invention can, in one embodiment, exhibit a percentage of volumetric shrinkage that is less than about 6.0% when dried under conditions effective to at least substantially remove the liquid vehicle from the plugging mixture. In another embodiment, the plugging mixtures of the present invention can even exhibit a volumetric shrinkage less than about 6.0%, less than about 4.0% or even less than about 2.0% when dried under conditions effective to at least substantially remove the liquid vehicle. The significant reduction or even elimination of drying shrinkage provided by the plugging mixtures of the present invention advantageously reduce or even eliminate the formation of drying cracks during the drying process. Drying shrinkage is measured relative to a fully wet mixture.

With reference to FIG. 4, a comparison of exemplary and non-limiting shrinkage data for conventional plugging mixtures and for plugging mixtures according to the present invention is provided. As shown, three plugging mixtures comprising at least 10% potato starch (denoted by hollow square symbols) and one plugging mixture comprising at least 10% microspheres (denoted by the solid triangular symbol) as a volumetric transformation agent were tested for their volumetric shrinkage as a function of the water addition in the plugging mixture. Each of the inventive plugging mixtures exhibited a percentage of volumetric shrinkage less than approximately 6.0% after drying, less than 4.0%, or even less than 2.0% after drying. In contrast however, the drying shrinkage for current conventional plugging mixtures resulted in an average shrinkage of at least approximately 7.0% and even as high as 12.0% (denoted by line “C”).

In still another embodiment, the plugging cement mixtures of the present invention are able to reduce or even eliminate the existence of undesirable dimple formation on the surface of the dried plugs and/or presence of generally vacuoles in the plug. As will be appreciated by one of ordinary skill in the art, dimples are depressions formed on the surface of a plug (interior and exterior surface) that appear shortly after plugging. Vacuole may also occur on the centerline of the plug and internal to the plug. Without wishing to be bound by any particular theory, it is believed that they are a result of a slip casting effect that occurs between the plug cement and the walls of the honeycomb body. In particular, liquid vehicle, such as water from the plugging mixture, cement can be wicked away by the walls, leaving behind a small void, typically in the center portion of the plug, thus manifesting itself as dimples and/or large vacuoles inside the plug body. The characteristics of the types of dimples and/or vacuoles formed on the surface can depend on several factors including for example, water content, cell geometry, wall material, and the like. In one embodiment, the plugging mixtures of the present invention can result in a reduction or even an elimination of the formation of these undesired dimples and/or vacuoles.

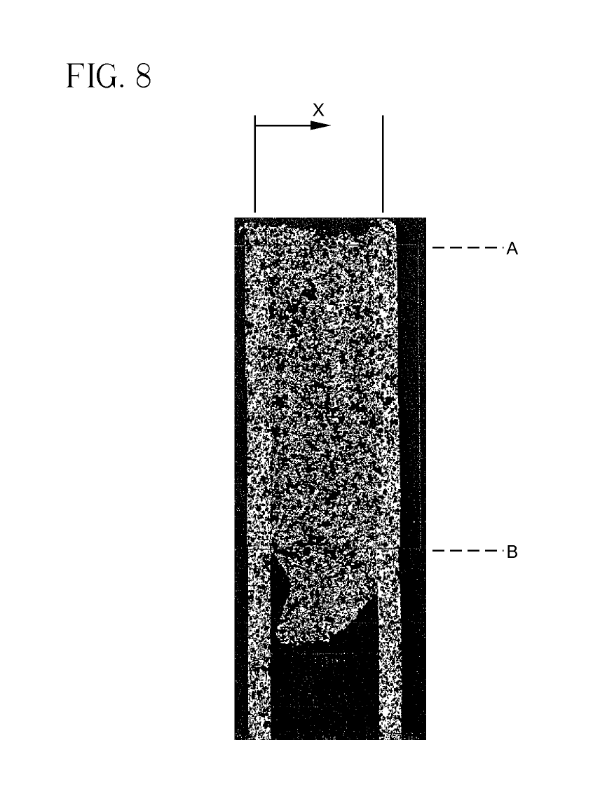

Further, upon firing, according to another aspect of the invention, the Sectional Numerical Aperture (SNA) of the fired plug may be substantially uniform, as measured across the plug's transverse width (see arrow labeled “X” in FIG. 8). The SNA is measured by a scanning electronic microscope (SEM) photograph of a cross-section on an Image Pro plus (tradename) available from Media Cybernetics Inc. Moreover, the total porosity of the plug is substantially uniform throughout and in particular, across the width of the plug, but also along the length. For example, the sectional numerical aperture may vary by less than 10% across the width of the plug from wall to adjacent wall, or even less than 8%.

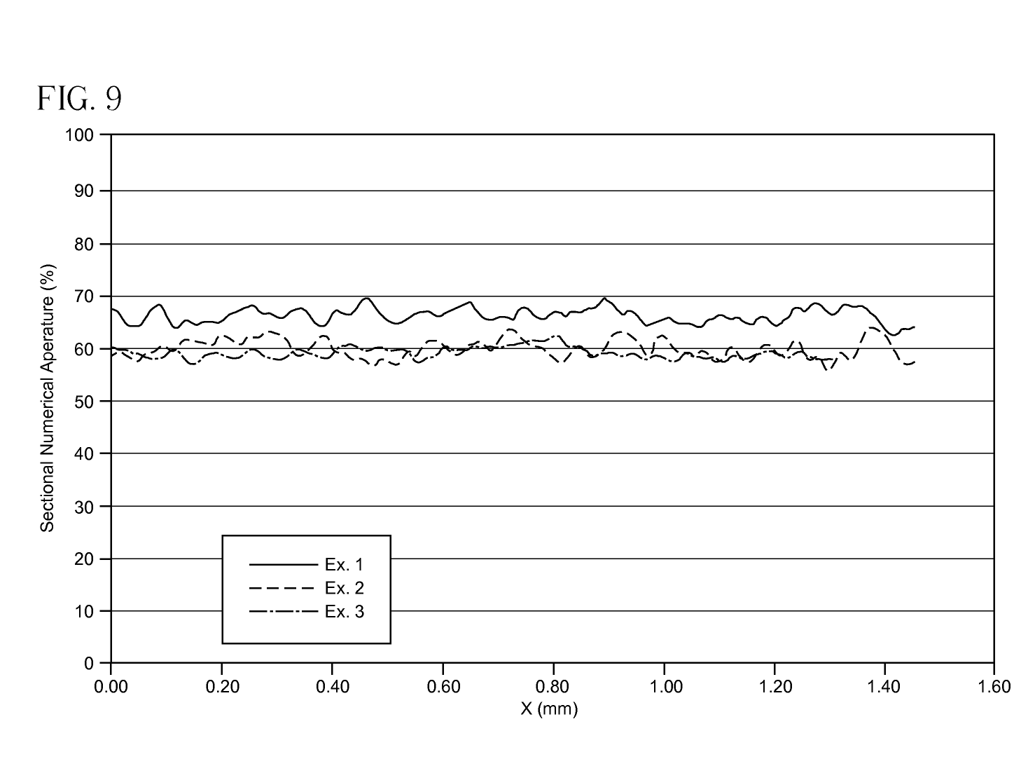

Additionally, the SNA adjacent the wall and at the center of the plug, for example may be substantially the same. FIGS. 8 and 9 illustrate the relatively uniform porosity and sectional numerical aperture (%) across the width of the plug in accordance with these aspects of the invention. In particular, although there is a slight variation in the measured SNA across the width of the plug, the local average, taking into account the average of SNA values within +/−0.2 mm from the point of measurement remains substantially constant across the width. In other words, the local average is not lower adjacent the walls than at the center of the plug. Accordingly, the local average is substantially constant across the width of the plug.

FIG. 8 illustrates graphically an enlarged (50×) polished cross-section of a representative plug illustrating the substantial uniformity of the total porosity in the fired plug across a width thereof, and also along its length (in a direction aligned with the length of the cell channel). Similarly, FIG. 9 represents actual test data of the sectional numerical aperture (%) versus the distance X (mm) as measured across the width of a representative plug made using the cement according to the invention. Sectional numerical aperture is defined herein as the total length along a representative vertical section of the plug (along the long dimension of the plug and parallel with the central axis of the plug) ignoring irregularities at each end (measurements only between lines labeled A and B) divided by the length of the void space (due to plug porosity) along that same total length times 100. Representative readings are taken along the width, from one wall to the adjacent wall, at short spaced intervals. The width of the measurement area is 4 pixels (0.0103 mm) and depending on the cell width, between 120 and 150 readings are taken and plotted as in FIG. 9. The equation for Sectional Numerical Aperture (SNA) at any particular X dimension is as follows: SNA (%)=(Total LengthNoid length)×100.

Table 1 below illustrates data from representative fired plugs of several examples (A-C) of the present invention honeycomb filter. The fired plugs are formed from the cement formulation of the present invention. Mean measured SNA (%), minimum measured SNA (%), maximum measured SNA (%), and SNA standard deviation (%) is provided.

TABLE 1
Example Plug SNA data

| Exam- | Mean | Min | Max | Std. Dev. | Max Diff (%) |
|---|---|---|---|---|---|
| ple | SNA (%) | SNA (%) | SNA (%) | SNA (%) | from Average |
| A | 65.9 | 61.9 | 69.5 | 1.4 | 6.1 |
| B | 59.6 | 55.1 | 63.5 | 1.9 | 7.5 |
| C | 58.9 | 56.8 | 62.1 | 1.1 | 5.4 |

From the above data, it is evident that the % difference from average SNA is less than 10%, less than 8%, less than 7%, and in some embodiments, less than 6%. The standard deviation from the mean SNA is less than 2%. This data illustrates that the SNA is substantially constant across the plug width from wall to adjacent wall.

After drying, the plugging mixtures as described herein can be fired under conditions effective to convert the plugging material into a primary sintered phase ceramic composition. The effective firing conditions will depend in part on the particular composition of the plugging material. However, effective firing conditions will typically comprise firing the plugging material at a maximum firing temperature in the range of from about 1300° C. to about 1500° C., and more preferably at a maximum firing temperature in the range of from 1375° C. to 1425° C.

In one embodiment, the step of firing the plugging material can be a “single fire” process. According to this embodiment, the selectively end plugged honeycomb substrate is a green body or unfired honeycomb body comprised of a dried plasticized ceramic forming precursor composition. The conditions effective to fire the plugging mixture are also effective to convert the dried ceramic precursor composition of the green body into a sintered phase ceramic composition. Further according to this embodiment, the unfired honeycomb green body can be selectively plugged with a plugging mixture having a composition that is substantially equivalent to the inorganic composition of the honeycomb green body. Thus, the plugging material can for example comprise either the same raw material sources or alternative raw material sources chosen to at least substantially match the drying and firing shrinkage of the green honeycomb. As stated above, the conditions effective to simultaneously single fire the plugging mixture and the green body can comprise firing the selectively plugged honeycomb structure at a maximum firing temperature in the range of from 1350° C. to 1500° C., and more preferably at a maximum firing temperature in the range of from 1375° C. to 1425° C. After firing, the finished plugs should also exhibit similar thermal, chemical, and/or mechanical properties to that of the honeycomb body.

In an alternative embodiment, the step of firing the plugging material can be a “second fire” process. According to this embodiment, the provided honeycomb substrate has already been fired to provide a ceramic honeycomb structure prior to selectively end plugging the honeycomb substrate with the plugging mixture of the present invention. Accordingly, the conditions effective to fire the plugging mixture are those effective to convert the plugging mixture into the ceramic composition. To this end, it can be desirable to selectively plug one or more channels of the honeycomb body with a plugging mixture that will result in a plug with physical properties similar to the honeycomb, but which can be fired without altering the properties of the pre-fired honeycomb substrate. For example, a plugging mixture according to this embodiment can be chosen to lower the peak firing temperature required for firing of the plugs to a temperature below the peak firing temperature of the fired ceramic honeycomb body. For example, a cordierite-based plugging material of the invention may be used to plug an aluminum titanate substrate.

Once again, the conditions effective to fire the plugging mixture in a second fire process can comprise firing the selectively plugged honeycomb structure at a maximum firing temperature in the range of from 1300 to 1500° C., 1350° C. to 1500° C., and even at a maximum firing temperature in the range of from 1375° C. to 1425° C. After firing, the finished plugs should also exhibit similar thermal, chemical, and/or mechanical properties to that of the honeycomb body.

### EXAMPLES

To further illustrate the principles of the present invention, the following examples are put forth so as to provide those of ordinary skill in the art with a complete disclosure and description of how the ceramic cement mixtures, articles, and methods claimed herein are made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations may have occurred. Unless indicated otherwise, parts are parts by weight, temperature is ° C. or is at ambient temperature, and pressure is at or near atmospheric.

### Example 1

### Evaluation of Potato Starch as Volumetric Expansion Agent

Two exemplary inventive cordierite based plugging mixtures comprising potato starch as a volumetric transformation agent were prepared and evaluated in comparison to a conventional cordierite plugging cement that contained a graphite pore former in place of the potato starch volumetric transformation agent. The specific formulations for the various plugging mixtures are set forth in Table 1 below:

TABLE 1

| | | | | |
|---|---|---|---|---|
| | MPS | Comp. A | Inv. 1 | Inv. 2 |
| Component | (μm) | Wt. % | Wt. % | Wt. % |

Inorganics

| | | | | |
|---|---|---|---|---|
| Talc | 23.5 | 40.7 | 40.7 | 40.7 |
| Alumina A | 3.4 | 14.8 | — | — |
| Alumina B | 6.8 | — | 14.8 | 14.8 |
| Kaolin Clay | 3.2 | 16.0 | 16.0 | 16.0 |
| Hydrated Alumina A | 4.6 | 16.0 | — | — |
| Hydrated Alumina B | 9.0 | — | 16.00 | 16.00 |
| Silica | 26.2 | 12.5 | 12.5 | 12.5 |
| Total Inorganics | | 100.0 | 100.0 | 100.0 |

Poreformer

| | | | | |
|---|---|---|---|---|
| Graphite | 123.8 | 15.0 | — | — |
| Potato Starch | 47.8 | — | 10.0 | 10.0 |

Organics

| | | | | |
|---|---|---|---|---|
| Liga | 33.9 | 0.25 | 0.45 | 0.45 |
| Methocel (F4M) | 60.6 | — | — | 0.85 |
| Methocel (F240) | 60.6 | 0.75 | 0.75 | — |

Liquid Vehicle

| | | | |
|---|---|---|---|
| Water | 27.00 | 24.00 | 24.00 |

Once prepared, the plugging cement mixtures were then used to plug channels in cordierite based honeycomb bodies to produce filters. After plugging operation was complete, the plugging cement mixtures were dried to at least substantially remove the water from the plugging mixture. A visual inspection of the plugs after the drying process indicated that the plugging mixture of comparative formulation A resulted in plug depth variability wherein the visual quality of the plugging material was acceptable when relatively deeper plugs were used on the perimeter of the honeycomb part. In contrast, visual inspection of the plugging materials of inventive formulations 1 and 2 plugged well with minimal or no plug depth variability and excellent plug porosity uniformity. Additionally, even a small weight percentage of the starch may cause significant plug total porosity upon firing; for example, in excess of 50%, 55% or even 60% total porosity.

Additionally, four plugging materials, similar in composition to those of inventive formulations 1 and 2 were also prepared to evaluate the drying shrinkage percentage as a function of varying amounts of potato starch as the volume transformation agent. In particular, each of the four compositions contained approximately 24 total weight percent of water as the liquid vehicle and further comprised 1 wt. %, 2 wt. %, 5 wt. % and 10 wt. %, respectively, of potato starch. The plugging mixtures were then substantially dried by heating for approximately 6 hours at 110° C. and evaluated in terms of the percentage of volumetric shrinkage resulting from the drying process. The results of the shrinkage evaluation are set forth in Table 2 below:

TABLE 2

| Wt. % Starch | Water Total (%) | Drying Shrinkage (%) |
|---|---|---|
| 1 | 24 | 5.17 |
| 2 | 24 | −0.93 |
| 5 | 24 | 0.35 |
| 10 | 24 | 0.27 |

As is evident from the above data, even a small addition of the potato starch as the volume transformation agent produces significant reductions in the % drying shrinkage. For example, addition of greater than or equal to 2 wt. % starch (e.g., potato starch) reduces drying shrinkage to less than 1%. Thus, potato starch is an extremely effective volume expansion agent and substantially reduces drying shrinkage of the cement.

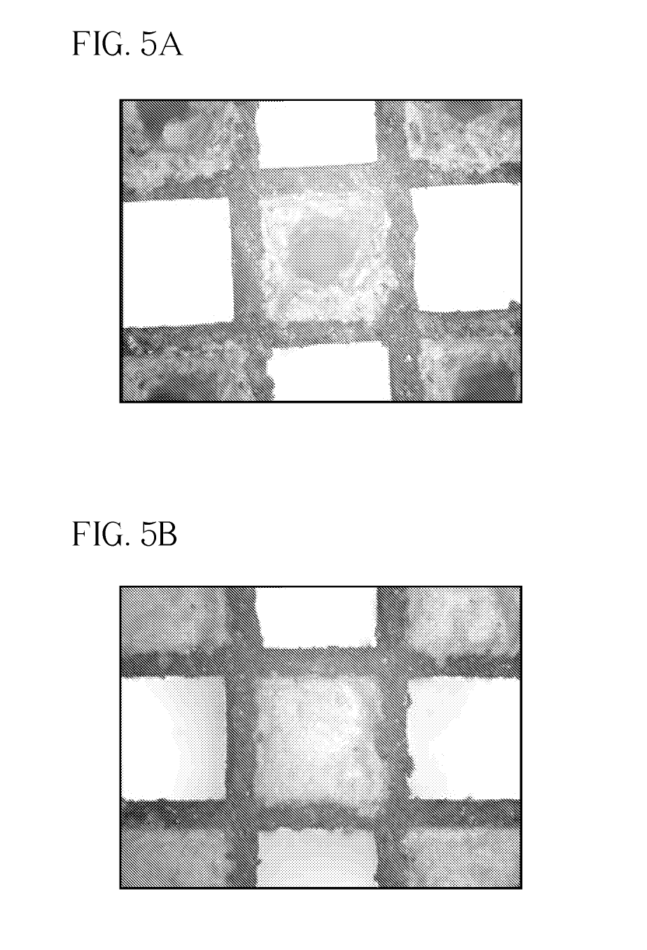

FIGS. 5A and 5B illustrate a comparison of the presence of dimple formation that results from a conventional plugging mixture (FIG. 5A) compared to a plugging mixture of the present invention and similar to those of Inventive formulations 1 and 2. As shown, the conventional plugging mixture resulted in the formation of visible dimples in the center portion of the plug. In contrast, FIG. 5B reveals that no visible dimples are present on the plugs formed from the inventive plugging mixtures.

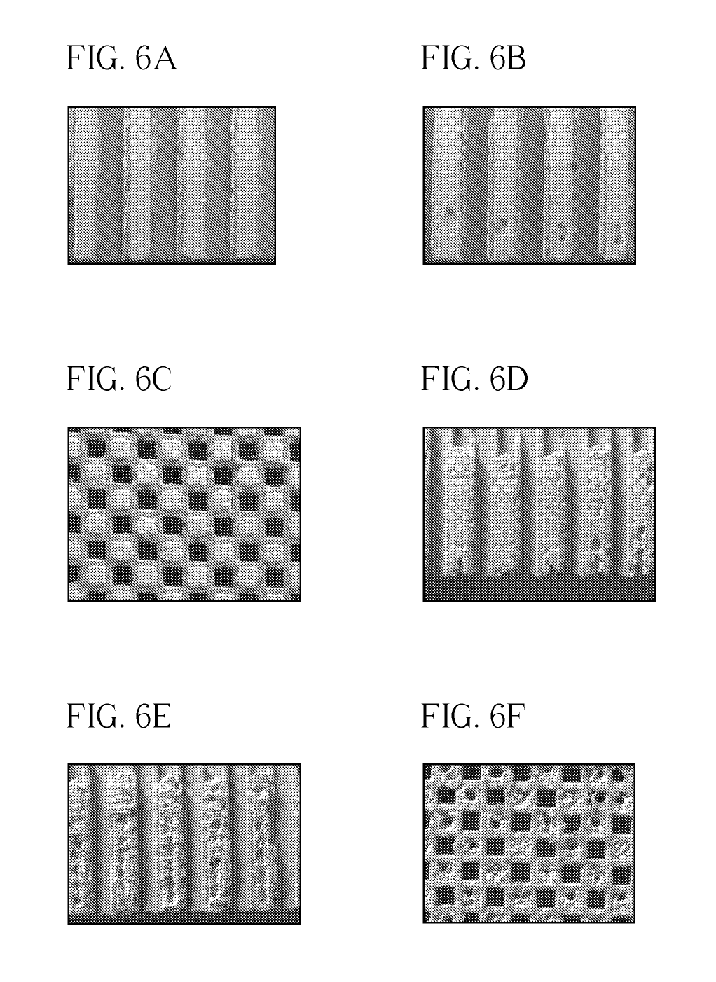

Likewise, FIGS. 6A-6F illustrate a comparison of cross sectional and top views of inventive plugging mixtures similar to those of Inventive formulations 1 and 2 with conventional plugging materials similar to that of Comparative A formulation. In particular, FIGS. 6A-6C illustrates two cross sectional views and one top view of an inventive plugging mixture. It can be seen that the dried plugging mixture resulted in the formation of few or even no drying cracks and similarly resulted in no visible dimples on the surface of the plug. FIGS. 6D-6F also illustrates two cross sectional views and one top view of a conventional plugging mixture. In contrast to the mixture depicted in FIGS. 6A-6C, the conventional plugging mixture resulted in the formation of significant drying cracks as well as visible dimples on the surface of the end plug.

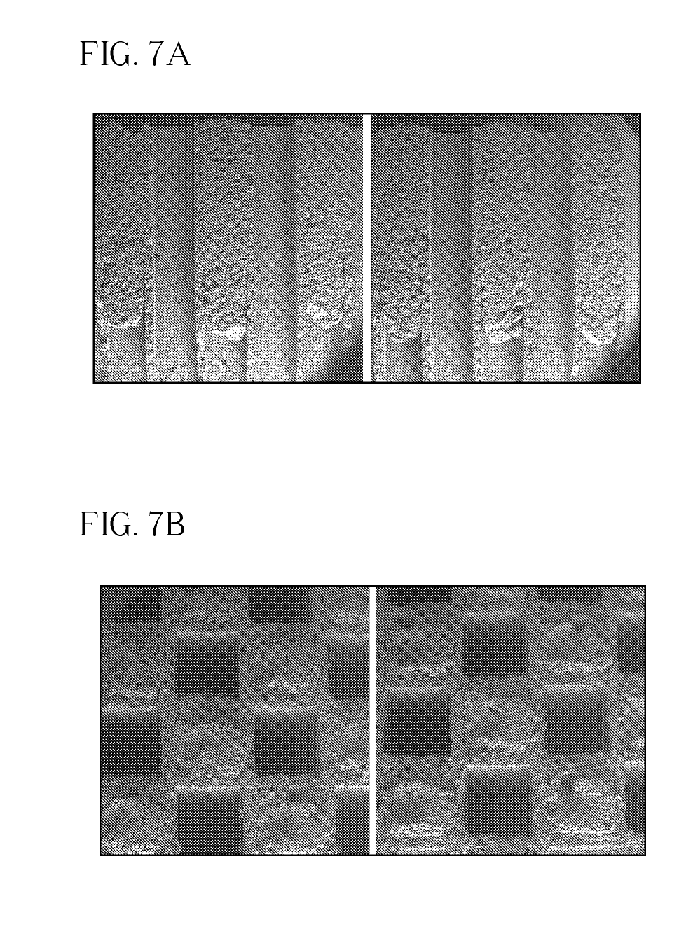

Still further, FIGS. 7A and 7B illustrates cross sectional and top views, respectively, of an inventive plugging mixture after firing to convert the plugging mixture into a primary sintered phase ceramic composition. Once again, it can be seen that after firing, the plugging mixture resulted in the formation of few or even no drying cracks and similarly resulted in no visible dimples on the surface of the plug.

### Example 2

### Evaluation of Microspheres as Volumetric Expansion Agent

Four exemplary inventive cordierite based plugging cement mixtures including varying amounts of Expancel® microspheres as the non-foaming, volumetric transformation agent were prepared and evaluated in comparison to a conventional cordierite plugging cement that contained graphite pore former in place of the microspheres volumetric transformation agent. The specific formulations for the various plugging mixtures are set forth in Table 3 below:

TABLE 3
Plug Cement Compositions

| | | | | | | |
|---|---|---|---|---|---|---|
| | MPS | Comp. B | Inv. 3 | Inv. 4 | Inv. 5 | Inv. 6 |
| Component | (μm) | Wt. % | Wt. % | Wt. % | Wt. % | Wt. % |

Inorganics

| | | | | | | |
|---|---|---|---|---|---|---|
| Talc | 23.5 | 40.7 | 40.7 | 40.7 | 40.7 | 40.7 |
| Alumina | 3.4 | 14.8 | 14.8 | 14.8 | 14.8 | 14.8 |
| Kaolin | 3.2 | 16.0 | 16.0 | 16.0 | 16.0 | 16.0 |
| Clay | | | | | | |
| Hydrated | 4.6 | 16.0 | 16.0 | 16.0 | 16.0 | 16.0 |
| Alumina | | | | | | |
| Silica | 23.4 | 12.5 | 12.5 | 12.5 | 12.5 | 12.5 |
| Total | | 100.0 | 100.0 | 100.0 | 100.0 | 100.0 |
| Inorganics | | | | | | |

Poreformer

| | | | | | | |
|---|---|---|---|---|---|---|
| Graphite | 123.8 | 12.88 | — | — | — | — |
| Micro- | 10.0 to | — | 1.0 | 2.0 | 5.0 | 10.0 |
| spheres | 16.0 | | | | | |
| 642 WU 40 | | | | | | |

Organics

| | | | | | |
|---|---|---|---|---|---|
| Liga | 0.25 | 0.25 | 0.25 | 0.25 | 0.25 |
| Methocel | 1.03 | 1.03 | 1.03 | 1.03 | 1.03 |
| (F240) | | | | | |

Liquid Vehicle

| | | | | | |
|---|---|---|---|---|---|
| Water | 28% | 24% | 24% | 24% | 24% |

Additionally, four plugging materials, similar in composition to those of inventive formulations 3, 4, 5 and 6 were also prepared to evaluate the drying shrinkage percentage as a function of varying amounts of expandable Expancel® microspheres as the non-foaming, volume transformation agent. In particular, each of the four compositions contained approximately 24 total weight percent of water as the liquid vehicle and further comprised 1 wt. %, 2 wt. %, 5 wt. % and 10 wt. %, respectively, of Expancel® micro-spheres (642 WU 40). The plugging mixtures were then substantially dried by heating for 12 hours at 85° C. to evaluate the percentage of volumetric shrinkage resulting from the drying process. The results of the microsphere shrinkage evaluation are set forth in Table 4 below:

TABLE 4
Drying Shrinkage

| % Expancel | Water Total (%) | Drying Shrinkage (%) |
|---|---|---|
| 1 | 24 | 8.03 |
| 2 | 24 | 7.29 |
| 5 | 24 | 5.27 |
| 10 | 24 | 1.84 |

As is evident from the data above, addition of even a small amount of the polymer micro-balloons, such as greater than or equal to 5 wt. % causes a significant reduction in cement shrinkage percentage upon substantial drying of the cement. Addition of 10 wt % or more reduces shrinkage to less than 2%. Additionally, when used as a plugging cement, the invention may produce a plug with low shrinkage combined with relatively high total porosity (total porosity greater than 50%).

Lastly, it should also be understood that while the present invention has been described in detail with respect to certain illustrative and specific embodiments thereof, it should not be considered limited to such, as numerous modifications and uses are possible without departing from the broad scope of the present invention as defined in the appended claims. For example, the low drying shrinkage cement may be used for after applied skinning applications on substrate and/or filters, for example. In addition, the cement may be used to form plugs in substrates of different composition as compared to the cement. For example, the plug cement may be used to plug an aluminum titanate substrate, for example.

What is claimed is:

1. A plugging mixture for a ceramic wall flow filter, comprising:
a ceramic forming inorganic powder batch composition;
an organic binder;
a liquid vehicle; and
a non-foaming volume transformation agent having a volume transformation temperature (T_{VT}) wherein 50° C.≦T_{VT}≦200° C.

2. The plugging mixture of claim 1 wherein the ceramic forming inorganic powder batch composition is an aluminum titanate forming batch composition, comprising an alumina source, a silica source, and a titania source.

3. The plugging mixture of claim 1 wherein the ceramic forming inorganic powder batch composition is a cordierite forming batch composition, comprising a magnesia source; an alumina source; and a silica source.

4. The plugging mixture of claim 1 wherein T_{VT}≦120° C.

5. The plugging mixture of claim 4 wherein T_{VT}≦110° C.

6. The plugging mixture of claim 4 wherein 50° C.≦T_{VT}≦110° C.

7. The plugging mixture of claim 1 wherein the volume transformation agent comprises a starch.

8. The plugging mixture of claim 7 wherein the starch has a median particle size d₅₀ in the range of from 40 μm to 50 μm.

9. The plugging mixture of claim 1 wherein the volume transformation agent comprises gas encapsulated polymer microspheres.

10. The plugging mixture of claim 1 wherein the volume transformation agent is present as a super addition in an amount in the range of from 1.0 weight percent to 15 weight percent of the ceramic forming inorganic powder batch composition.

11. The plugging mixture of claim 1, wherein the plugging mixture exhibits a percentage of volumetric shrinkage less than 6.0% when dried under conditions effective to remove at least approximately 95% of the liquid vehicle as compared to a fully wet mixture.

12. A porous ceramic honeycomb filter, comprising:
a honeycomb substrate defining a plurality of cell channels bounded by porous walls that extend longitudinally from an inlet end to a outlet end; a portion of the cell channels including plugs sealed to the respective porous walls; and
wherein the plugs are formed from a plugging mixture comprising a ceramic-forming inorganic powder batch composition; an organic binder; a liquid vehicle; and a non-foaming volume transformation agent having a volume transformation temperature (T_{VT}) wherein 50° C.≦T_{VT}≦200° C.

13. A method for manufacturing a porous ceramic honeycomb filter, comprising the steps of:
providing a honeycomb structure defining a plurality of cell channels bounded by walls that extend longitudinally from an inlet end to an outlet end;
plugging at least one channel with a plugging mixture comprised of a ceramic-forming inorganic powder batch composition; an organic binder; a liquid vehicle; and a non-foaming volume transformation agent having a volume transformation temperature (T_{VT}) wherein 50° C.≦T_{VT}≦200° C.; and
firing the plugged honeycomb structure under conditions effective to form a sintered phase ceramic plug in the at least one plugged channel.

14. The method of claim 13, wherein the conditions effective to at least substantially remove the liquid vehicle comprise heating the plugging mixture at a temperature in the range of from 60° C. to 120° C.

15. The method of claim 13, wherein the plugging mixture exhibits a percentage of volumetric drying shrinkage less than about 6.0 percent when dried under conditions effective to remove at least approximately 95% of the liquid vehicle as compared to a fully wet mixture.

16. A plugging mixture for a honeycomb ceramic article, comprising:
a ceramic forming inorganic powder batch composition;
an organic binder;
a liquid vehicle; and
a non-foaming volume transformation agent,
wherein the plugging mixture exhibits a percentage of volumetric drying shrinkage less than about 6.0 percent when dried under conditions effective to remove at least approximately 95% of the liquid vehicle as compared to a fully wet mixture.

17. A cement mixture for a ceramic honeycomb article, comprising:
a ceramic-forming inorganic powder batch composition;
an organic binder;
a liquid vehicle; and
a volume transformation agent having a volume transformation temperature (T_{VT}) wherein T_{VT}≦120° C.

18. A green body honeycomb article, comprising:
a green body honeycomb structure defining a plurality of cell channels bounded by longitudinally extending walls;
a plug formed in at least one cell channel of the green body honeycomb structure wherein the plug contains a plugging mixture of a ceramic-forming inorganic powder batch composition; an organic binder; a liquid vehicle; and a non-foaming volume transformation agent having a volume transformation temperature (T_{VT}) wherein 50° C.≦T_{VT}≦200° C.

19. A porous ceramic honeycomb filter, comprising:
a porous ceramic honeycomb substrate having cell channels bounded by cell walls; a portion of the cell channels including plugs wherein a sectional numerical aperture measured across a width of the plug varies by less than 10% from wall to adjacent wall.

20. The porous ceramic honeycomb filter of claim 19, wherein the sectional numerical aperture varies by less than 8%.
